(19) United States
(12) Patent Application Publication
(10) Pub. No.: US 2009/0071069 A1
(43) Pub. Date: Mar. 19, 2009

(54) Landscaping edging stake having a pocket for resisting removal

(76) Inventors: Clemente Conde, Waco, TX (US); Jim W. Waalkes, Wyoming, MI (US)

Correspondence Address: O'KEEFE, EGAN, PETERMAN & ENDERS LLP, 1101 CAPITAL OF TEXAS HIGHWAY SOUTH, #C200, AUSTIN, TX, 78746, US

(21) Appl. No.: 11/900,796

(22) Filed: Sep. 13, 2007

(51) Int. Cl. E02D 5/80; A01G 1/08

(52) U.S. Cl. 47/33; 52/155

(57) ABSTRACT

A landscape edging stake is provided that has a relatively large pocket area formed at its bottom end. The pocket region is shaped such that upward motion of the stake will engage the pocket region with the soil in a manner resisting the upward motion. The exemplary pocket region has sides that extend outward at an angle from the main body of the stake so as to form a surface which will engage the soil when the stake is moved upward. The angle of the pocket sides is shown as an exemplary v-shaped angle which also serves to assist the insertion of stake. In this manner, the pocket is shaped such that it assists insertion but resists removal.

### TECHNICAL FIELD

The techniques described herein relate to a landscaping edging stake for assisting in retention of landscaping structures in the ground, and particularly a landscaping stake having a pocket for holding soil to aid in the stability of the stake and to prevent removal of the stake.

### BACKGROUND

Current landscaping devices include a variety of stakes for holding landscape edging in the ground. Landscape edging stakes may be formed integrally with the edging or may be a separate component configured to engage a piece of landscape edging. For example, a stake that is formed integral with the landscape edging may be comprised of a landscape edging section having extensions extending downward to form a stake feature. Stakes that separate from the edging provide greater flexibility in the location of the stake and often are configured to engage a portion of the edging, such as for example, a hook like portion of a stake which may engage the top of the edging.

Traditionally, landscape edging stakes have been relatively straight and smooth to enable ease of insertion in the ground. However, such stakes do not provide significant resistance to upward movement of the stake, such as for example that caused by soil heaving, and thus may become dislodge easily. Some current landscaping stakes comprise “barbs” for aiding in the stability of the stake and to prevent removal of the stake. Also some current stakes have lateral wings or fins for aiding in retention of landscaping structures in the ground.

It is desirable to provide a landscape edging stake that has improved retention capabilities as compared to such stakes while at the same time retains an ease of insertion.

### SUMMARY

A landscape edging stake is provided that has a relatively large pocket area formed at its bottom end. The pocket region is shaped such that upward motion of the stake will engage the pocket region with the soil in a manner resisting the upward motion. The exemplary pocket region has sides that extend outward at an angle from the main body of the stake so as to form a surface which will engage the soil when the stake is moved upward. The angle of the pocket sides is shown as an exemplary v-shaped angle which also serves to assist the insertion of stake. In this manner, the pocket is shaped such that it assists insertion but resists removal.

The techniques described herein provide a landscaping edging stake for assisting in the retention of landscaping edging structures in the ground. In one embodiment a landscaping edging stake for assisting in retention of a landscape edging structure in ground comprises a first side, a second side, the second side opposing the first side, and a bottom end. The bottom end may comprise a penetrating tip and at least one pocket extending out from the first side, the pocket configured to assist in the retention of the landscape edging stake in the ground, the pocket also configured to assist in the insertion of the landscape edging stake in the ground.

Another aspect of the techniques described herein provide a method for holding a landscape edging structure in place with a landscaping edging stake configured for assisting in retention of a landscaping structure in the ground. The method may comprise providing the landscape edging stake with a first side, a second side, a top end, a central portion, and a bottom end, the bottom end of the stake having at least one pocket, the pocket being shaped to assist insertion of the stake into the ground. The method may further include engaging the landscaping edging structure with the stake via a holding mechanism and utilizing the pocket to resist upward movement of the landscape edging stake.

As described below, other features and variations can be implemented, if desired, and a related method can be utilized, as well.

### DESCRIPTION OF THE DRAWINGS

It is noted that the appended drawings illustrate only exemplary embodiments of the techniques described herein and are, therefore, not to be considered limiting of its scope, for the techniques may admit to other equally effective embodiments.

FIG. 1 is a side view of a landscaping stake;

FIG. 2 is a diagram of a first side of the stake;

FIG. 3 is a diagram of a second side of the stake;

FIG. 4 is a cross-section view of the bottom end of the stake; and

FIG. 5 is a side view of the landscaping stake inserted in the ground holding a landscape edging material.

### DETAILED DESCRIPTION OF THE INVENTION

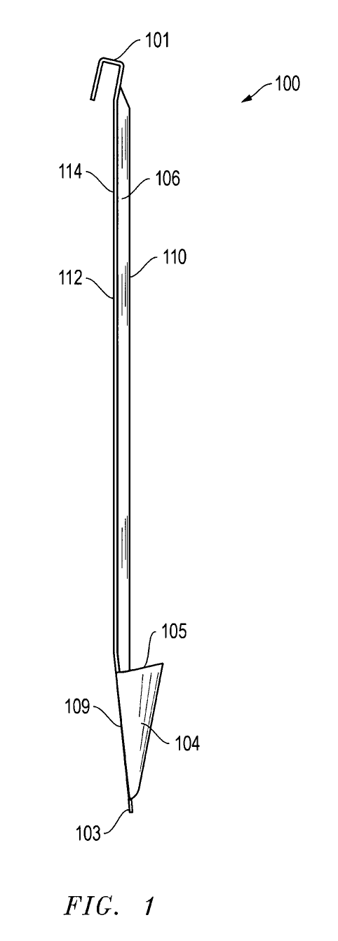

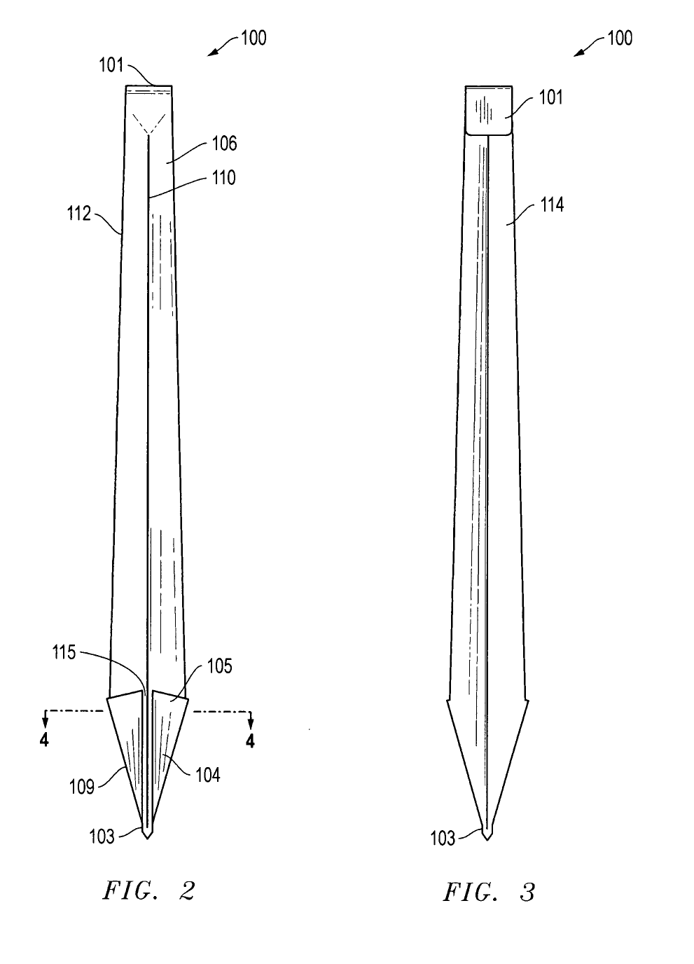

The techniques described herein provide a landscaping edging stake for assisting in retention of landscaping structures in the ground. FIG. 1 shows a side view of the landscaping edging stake 100 having a first side 106 and a second side 114. The landscape edging stake 100 also has a top end 101 comprising a holding mechanism configured to hold a landscaping structure or edging material. FIGS. 2 and 3 show other side views of the landscape edging stake 100. The holding mechanism at the top end 101 of the stake 100 is shaped to match the top of a landscaping structure or edging material that the stake is meant to mate with. It will be recognized that the holding mechanism shown herein is merely exemplary and concepts described herein may be utilized without the use of any holding mechanism. Further, though the exemplary holding mechanism is shown to engage the top edge of a landscape edging piece, other holding mechanisms may be utilized such as structures that snap together, engage at different locations of the edging or any other holding mechanism that assists in keeping the edging and the stake engaged (whether formed on the stake, the edging or both).

As shown in FIG. 1, the top end 101 of the stake 100 is curved toward the second side 114 of the stake. In the example shown, the two 90 degree angles result in one side of the top end 101 meant to be parallel to the ground during use, and another side parallel to the central portion 112 of the stake 100. In another alternative, the top end 101 of the stake 100 can be curved in a U-shaped curve to fit landscaping structures or edging material. Also, the top end 10 could be curved toward the first side 106 instead of the second side 114.

The first side 106 of the stake 100 has a bend 110 extending vertically down the length of the stake 100 from the central portion 112 of the stake 100 to the penetrating tip 103 located at the bottom end 109 of the stake 100. In the example shown, the bend 110 causes the first side 106 to bend back towards the second side approximately 30 degrees. This vertical bend 110 adds strength to the stake allowing greater rigidity to the stake when force used during insertion of the stake 100 into the ground, and thus prevents breakage during use. It will be recognized that other angles for the bend may be utilized as the degree of bend may be a design choice depending upon the material for which the stake is formed, the manufacturing techniques utilized, aesthetic qualities, etc. In fact, the use of any bend at all is optional as the concepts described herein do not require the use of such a bend.

The bottom 109 of the stake 100 comprises at least one pocket 105 and a penetrating tip 103. The penetrating tip 103 aids in insertion of the stake 100 into the ground. In one embodiment, the bottom 109 of the stake comprises a V-shaped pocket 105 starting close to the penetrating tip 103 of the stake 100. The pocket 105 is configured to hold soil and resist upward movement of the stake after insertion into the ground. This pocket 105 is formed by at least one pocket side 104. In the example shown, the pocket 105 may extend edge to edge of the width of the central portion 112 of the stake 100. In the embodiment shown, there are two pocket sides 104 that leave a lengthwise opening 115. The pocket may however be formed in any number of other shapes and sizes. Further, multiple pockets may be formed, for example two pockets may be formed on the first side 106 and/or one or more pockets may be formed on the second side 114. It will be recognized that in the embodiment shown the extension of the pocket 105 from across the entire width of the first side 106 provides for a relatively large pocket volume size that increasing the retention capabilities of the pocket. Other pocket sizes may be utilized.

FIG. 2 shows a view of the first side 106 of the landscaping edging stake 100. The first side 106 of the stake 100 has a vertical bend 110 extending from the central portion 112 lengthwise to the penetrating tip 103. So as to assist engagement of the landscape edging stake with a piece of landscape edging, the vertical bend 110 is not at the top end 101 of the stake 100. FIG. 2 shows a front view of the pocket sides 104 having a pocket 105 area therein. In FIG. 2, the pocket sides 104 leave a lengthwise opening 115 down the center of the pocket sides 104. It is understood that the pocket sides 104 can meet in the middle having no opening, or that the opening can occur on one side or the other of the pocket 105 and need not be centered. The pocket sides 104 create a pocket area 105 configured to hold soil once the stake 100 is inserted into the ground, thus preventing easy removal of the stake 100 and assisting in holding the stake 100 in place under various conditions, i.e., soil movement due, to various weather patterns, external friction by animals or humans, or the like. The pocket sides 104 taper, becoming more narrow at the bottom 109 of the stake close to the penetrating tip 103. The pocket sides 104 may narrow to actually form the penetrating tip 103 or alternatively the penetrating tip 103 may be separated and extended downward from the bottom of the pocket sides 104. FIG. 3 shows the second side 114 of the stake 100, (or a rear view of the stake 100).

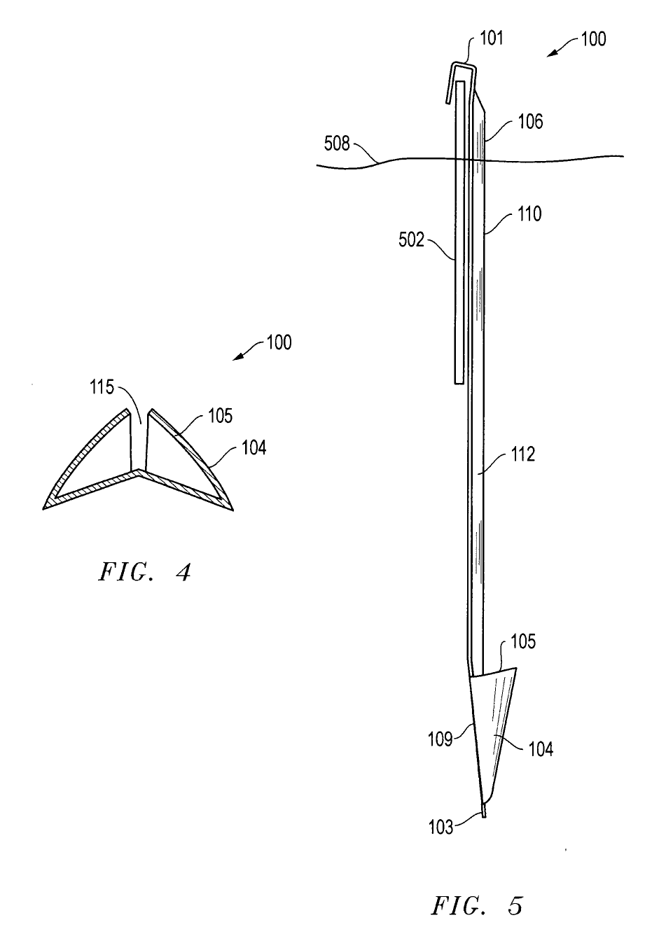

FIG. 4 shows a cross section along section line 4-4 of FIG. 2 illustrating the pocket 105 area at the bottom of the stake 100. The pocket sides 104 create a hollow opening or pocket 105 at the bottom of the stake 100. As shown the pocket sides 104 do not meet, but leave a lengthwise opening 115, however, such an opening is optional. In the example shown, the vertical length of the pocket 105 is at least 10) the length of the stake and more preferably at least 15% of the length of the stake. The size of the pocket may be chosen depending upon the needs of a user, i.e. a larger pocket 105 would hold more soil, have a larger cross-sectional area providing resistance to upward movement, increase stability and/or cause removal of the stake 100 to be more difficult.

FIG. 5 shows a side view of the landscaping edging stake 100 in use. As shown in FIG. 5 a landscaping structure 502 or edging material is inserted into the ground 508 and is held in place through engagement with the landscape edging stake 100 The curved top end 101 of the stake 100 is designed to fit the top of the landscaping structure 502. The penetrating tip 103 of the stake I 00 has been inserted into the ground 508, by applying blunt force to the top end 101 of the stake by hand or with some other implement, such as a hammer. The bend 110 in the central portion 112 and bottom 109 of the stake add strength to the stake 100 to allow the stake 100 to withstand the force necessary for inserting the stake 100 into the ground. The funnel-like v-shape of the pocket sides 104 also aid in insertion of the stake 100 into the ground 508. The pocket 105 holds soil and provides a surface area that is not parallel to the insertion direction to increase stability of the stake 100 and prevent removal of the stake 100.

As described above a landscape edging stake is provided that has a relatively large pocket area formed near its bottom end. The pocket region is shaped such that upward motion of the stake will engage the pocket region with the soil in a manner resisting the upward motion. As shown in the figures the exemplary pocket region has sides that extend outward at an angle from the main body of the stake so as to form a surface which will engage the soil when the stake is moved upward. The angle of the pocket sides is shown as an exemplary v-shaped angle which also serves to assist the insertion of stake. In this manner, the pocket is shaped such that it assists insertion but resists removal.

While the example described herein for the stake 100 illustrates the stake as independent of the landscaping structure 502 or edging material, it is understood that the stake 100 can be integral with the landscaping structure 502 or edging material. Thus, a stake 100 may be formed in a unitary manner with a piece of landscape edging. In such an embodiment it may be unnecessary to provide a top end of the stake with a holding mechanism. Rather, the stake may be formed as an extension of the edging material that merely extends downward from the edging. In such circumstances the central portion 112 and bottom end 109 (having a pocket as described below) may extend downward from the edging. Alternatively, the stake portion of the integral edging/stake piece may merely be an extension resembling the bottom end 109 having a pocket.

In one embodiment, the stake described herein may be made of metal. The various bends and angles of the stake may thus be formed via standard metal bending techniques. Alternatively, the stake can be made of plastic, fiberglass, or some other similar material and may be manufactured via molding, extrusion or any other manufacturing technique.

As described herein one suggested use of the stake disclosed above is for landscape edging applications. The techniques provided herein may be useful, however, in other applications. For example, the stake provided herein may be useful as a stake for camping tents, canvas tarps, trees, netting, fencing, etc. In such alternative applications, the top end 101 may still be curved as described in the figures above with reference to a top end that conforms to a shape of a segment of landscape edging. The top end may however, be configured in other manners that are more suited for such other applications. For example, the top end may be configured to engage a camping tent cord, a canvas tarp eyelet, etc. Alternatively the top end may be configured relatively straight without an additional features. It will be recognized that such alternative top ends may be used while still obtaining the advantages of the bottom pocket configured as described above.

Further modifications and alternative embodiments of the techniques described herein will be apparent to those skilled in the art in view of this description. It will be recognized, therefore, that the techniques described herein are not limited by these example arrangements. Accordingly, this description is to be construed as illustrative only and is for the purpose of teaching those skilled in the art the manner of carrying out the techniques described herein. It is to be understood that the forms of the techniques described herein shown and described are to be taken as the presently preferred embodiments. Various changes may be made in the implementations and architectures. For example, equivalent elements may be substituted for those illustrated and described herein and certain features of the techniques described herein may be utilized independently of the use of other features, all as would be apparent to one skilled in the art after having the benefit of this description of the techniques.

1. A stake configured to be engaged in the ground, comprising:
a first side;
a second side, the second side opposing the first side;
a central portion extending between a top end of the stake and a bottom end of the stake, the central portion also extending along a width of the stake; and
a bottom end comprising a penetrating tip and at least one pocket extending out from the first side, the pocket configured to assist in the retention of the stake in the ground, the pocket also configured to assist in the insertion of the stake in the ground, the penetrating tip being formed to be narrower along the width direction of the stake as compared to the width of the stake at the central portion.

2. The stake of claim 1, wherein the stake is configured for use as a landscape edging stake and further comprises the top end comprising a holding mechanism configured to hold a landscaping edging structure.

3. The stake of claim 2, wherein the holding mechanism is shaped to match a top part of the landscaping structure.

4. The stake of claim 1, wherein at least part of the stake has a bend extending vertically parallel to a height of the stake.

5. The stake of claim 1, wherein the pocket comprises a V-shaped pocket.

6. The stake of claim 1, wherein a vertical height of the pocket comprises at least 10% of a stake height.

7. The stake of claim 1, wherein the pocket extends from edge to edge of a width of the bottom end of the stake.

8. The stake of claim 1, wherein the stake is a landscape edging stake that is integral with a landscaping edging structure.

9. The stake of claim 1, wherein the stake is a landscape edging stake and the pocket comprises a V-shaped pocket.

10. The stake of claim 1, wherein the stake is a landscaping edging stake.

11. A metal landscaping edging stake for assisting in retention of a landscaping structure in the ground, comprising:
a first side;
a second side;
a top end comprising a holding mechanism configured to hold the landscaping structure;
a central portion; and
a bottom end, the bottom end comprising at least one V-shaped pocket and a penetrating tip,.wherein said pocket is configured to resist removal of the stake after insertion of the stake into the ground,
wherein the penetrating tip narrows to a V shape in at least a width direction of the stake such that a width of the bottom end at the penetrating tip is less than a width of the stake at the central portion of the stake.
wherein the pocket extends from edge to edge of a width of the bottom end of the landscaping edging stake, and
wherein the landscaping edging stake is independent from the landscaping structure.

12-21. (canceled)
